(19) United States
(12) Patent Application Publication
(10) Pub. No.: US 2009/0107000 A1
(43) Pub. Date: Apr. 30, 2009

(54) Method and Device for Freeze-Drying Products

(76) Inventor: Georg-Wilhelm Oetjen, Luebeck (DE)

Correspondence Address: Fay Sharpe LLP, 1228 Euclid Avenue, 5th Floor, The Halle Building, Cleveland, OH, 44115, US

(21) Appl. No.: 10/589,517

(22) PCT Filed: Feb. 1, 2005
(86) PCT No.: PCT/EP2005/000958

§ 371 Date: Aug. 16, 2006

(30) Foreign Application Priority Data
Feb. 17, 2004 (DE) 10 2004 007 526.3

(51) Int. Cl. F26B 5/06

(52) U.S. Cl. 34/284

(57) ABSTRACT

The invention relates to a method and to a device for freeze-drying products using a chamber (1) having surfaces (2), whose temperature can be regulated, and condensation surfaces (5). Water penetrating from the product in the form of vapour condenses on the surface of the condensation surfaces, and measurements are taken on the documentation of the process during the freeze-drying process. The aim of the invention is to improve the freeze-drying process in relation to the documentation thereof and, at the same time, to reduce technical complexity of the device which is suitable for carrying out said method. As a result, running of the vapour flow is determined between the product and the condensation surfaces (5) and the amount of water penetrating from the product in the form of vapour is calculated by means of temporal integration.

### BACKGROUND

The invention relates to a method for freeze-drying products using a chamber having surfaces whose temperature can be regulated, and a condenser, relative to which water issuing from the product in form of water vapor precipitates on the surface of the condenser and measurements are taken during the course of the freeze-drying process for documentation of the process. In addition, the invention relates to a device suitable for executing said process.

Freeze-drying is a method for removing water from a water-containing frozen product, for example from pharmaceutical products or food items. The method is generally performed at an air pressure which is low vis-à-vis the water vapor pressure of the selected ice temperature. For example, an ice temperature of −20° C. corresponds to a water vapor pressure (in equilibrium) of 1.03 mbar. In order for the water vapor to flow from the surface of the ice into the drying chamber, the water vapor pressure in the drying chamber must clearly be lower than 1.03 mbar, in other words, 0.5 mbar for example. Therefore, it is appropriate to select a low pressure relative to said pressure value, for example 0.15 mbar. Freeze-drying traditionally takes place in a chamber in which placement surfaces are located whose temperature can be regulated and which is connected, by means of a valve, with an evacuation device, for example an ice condenser combined with a vacuum pump.

Characteristic for the course of the drying process are, essentially, two drying phases. As long as crystallized (frozen) water still remains in the product, one calls said drying phase the “Primary- or Sublimation Drying”. During the primary drying, the temperature of the product must not exceed certain, mostly far below 0° C. positioned values, in order to avoid lowering the quality and/or the properties of the product. With progressive drying, the ice nuclei existing in the product become smaller and smaller. If there is no longer any water present in the form of ice, the remaining water is absorbed at the drying product or is more or less firmly bound. The removal of said water takes place during an after-drying or desorption drying. The desorbable amount of water during said phase depends upon the temperature of the product, the type of water bond and the respectively still present water amount. The after-drying is initiated by another change of the physical conditions determining the course of the drying process.

It is a known fact that the course of a freeze-drying process is documented and controlled by means of thermodynamic data which are measured during the drying course (compare Georg-Wilhelm Oetjen, Peter Haseley “Freeze-Drying” pages 273 etc., Wiley Publishing House, Weinheim, 2004).

The content of U.S. Pat. No. 6,163,979 is also part of the state of the art. This document discloses how the temperature on the sublimation front, or the temperature of the ice which is enclosed in the product to be dried, can be used for control of the principal drying and the transition from the principal drying to the after-drying.

During the principal drying, measurement of the ice temperature is taken in such manner that the valve between the freeze-drying chamber and the evacuation device is shut off for a brief moment (a few seconds). During this time, a balanced water vapor pressure occurs in the freeze-drying chamber, which corresponds to the prevailing ice temperature.

From the rise in pressure, it is possible to reach a direct conclusion as to the temperature of the ice. Said method for measuring the ice temperature is known under the term “barometric temperature measurement” and disclosed in DE-PS 10 38 988.

The described measuring of ice temperature is costly both technically and in terms of time. It presumes presence of a valve between freeze-drying chamber and evacuation device. Valve shut-off times not only extend the freeze-drying process itself, they are, in addition, connected with putting the product at risk. There is the danger that during the shut-off times, inadmissible temperature increases will occur in the ice-containing product, which lead to a lessening in product quality. The previously known measurement of ice temperature depends upon correct recognition of the saturated vapor pressure. This presumes a minimum amount of ice per chamber volume, in other words, in case of small amounts of ice in large drying chambers it is imprecise or impossible.

The present invention is based on the object of improving the course of a freeze-drying process relative to its documentation and to achieve, at the same time, a reduction of the technical expenditure in a device suitable for execution of said method.

### SUMMARY

According to the invention, said object is solved by means of the characteristic features of the patent claims.

The invention permits obtaining in simple fashion full knowledge at any time during the course of the freeze-drying process of how much water volume gets to the condenser or how much water is still present in the product. Pre-requisite is that the amount of water contained in the product is known at the start of the freeze-drying process. Said pre-requisite is always satisfied.

The water vapor flow is properly determined between product and condenser from on-going measurements (for example 10×100 times/s) of the partial water vapor pressure and the flow resistance relative to water vapor between the placement surfaces and the condenser. The partial water vapor pressure can be accurately measured, for example, with the aid of an infra-red analyzer. Such measurements depend upon proper recognition of the saturated vapor pressure, i.e. of a minimum amount of ice per chamber volume.

It is, moreover, of particular benefit, that the ice temperature no longer needs to be measured. The described technical and time-related expenditure connected with measuring the temperature of the ice is eliminated. The drying process can be documented and controlled by means of the already transported or still present water volume. In a device for executing the invention-specific method, one can forego the valve between freeze-drying chamber and evacuation device, whose diameter may measure up to 1 meter. In addition, there is the advantage that the product placement surfaces and the evacuation device can be located in one space.

Still further advantages of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 depicts a freeze-drying device with a chamber and a therewith connected condenser and

FIG. 2 depicts a freeze-drying device with a chamber in which is located, in addition to the placement surfaces, the condenser as well.

### DETAILED DESCRIPTION OF THE PREFERRED EMBODIMENTS

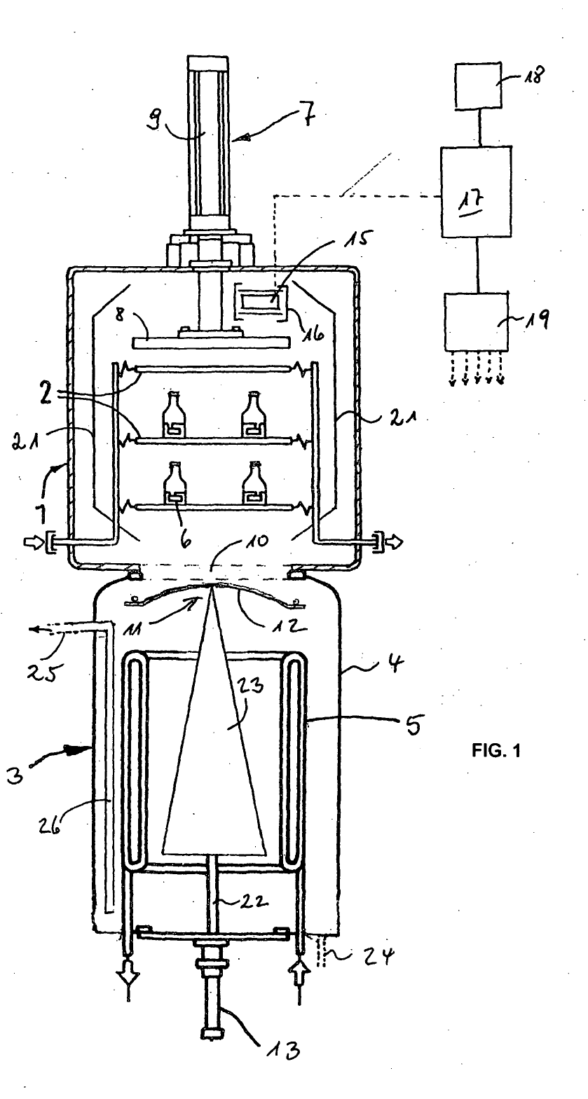

The in FIG. 1 depicted freeze-drying device comprises the chamber 1 with its placement surfaces 2 and the therewith connected condenser 3 with its chamber 4 and its condensation surfaces 5. On the placement surfaces 2 are arranged containers (small bottles 6) containing the product to be freeze-dried. The temperature of the placement surfaces 2 can be regulated. The placement surfaces are part of a temperature control circuit, which is not shown in detail, comprising refrigerator and transport pump. During the heating phase, the refrigerator is turned off and the refrigeration/heating medium heated electrically. An apparatus within the chamber 1 and serving for sealing of the small bottles 6 after execution of drying is generally identified with 7. It comprises the pressure plate 8 and the actuation device 9.

Between freeze-drying chamber 1 and condenser chamber 4 is located the opening 10, which is closable by means of valve 11 arranged on the side of the condenser. It comprises in the direction of the freeze-drying chamber 1 an arched valve plate 12 and adrive 13.

For drying the frozen product arranged in the small bottles 6, the required low pressure is first generated in chamber 1, and the temperature of the placement surfaces 2 regulated.

With open valve 11, the water vapor issuing from the product flows to the condensation surfaces 5 of the condenser 3. Little by little a decrease takes place in the still present water volume of the product.

In order to document what water volume still exists in the product or what water volume has already been transported, an instrument is utilized according to the invention, which constantly measures the partial water vapor pressure in chamber 1. In the figures, this is merely indicated as a block and identified with 15. It must be an instrument which accurately measures partial water vapor pressures and, to the extent possible, without inertia, that is to say between 1 mbar and 10⁻³ mbar with reproducibility of approximately 1%. Preferably an instrument is employed which utilizes the water vapor absorption bands in the infra-red spectral range. Instruments of this kind are sensitive to temperature fluctuations in the water vapor. For that reason, screening sheets 16 are schematically intimated surrounding the instrument 15, whose temperature can be regulated in order to adjust the temperature of the instrument 15 to a given value. Moreover, residual amounts of air are present in a freeze-drying device (for example 5-10%) and possibly traces of solvents from the production of the medicines and, perhaps, traces of food (for example CO₂ in coffee granulates). Infra-red spectroscopy permits selection of wave length in such manner that there will be no interference between water- and other bands or, if that should not be possible in exceptional cases, to mathematically analyze the absorption spectra in a way they would look without interference. A mass-spectrometer could also be used. Utilization of mass spectrometers for measuring partial water vapor pressures in freeze-drying chambers is, however, currently only possible with great technical expenditure.

The measuring instrument delivers as often as possible, preferably 10 to 100 times per second, electrical signals, which correspond to the respectively within the chamber 1 prevailing partial water vapor pressure. These signals are transferred to a computer 17, with the aid of which a calculation is made of the already transported water volume, and registered, for example, in the display 18. The computer 17 requires, in addition, information concerning the pressures and/or temperatures prevailing in chamber 1 (for example placement surface temperatures) in order to either take into account the pressure while ascertaining the water vapor flow or in order to initiate control procedures which require said information. Sensors and lines which serve for transmitting the information from the chamber to the computer 17 are not specifically represented.

Subject to the pre-requisites that the temperature fluctuations in the water vapor at the measuring site are not influenced by the temperatures of other structural components, for example doors and walls of the drying chamber, and that the flow velocity of the water vapor at the measuring site is small vis-à-vis the sound velocity, it is possible to quite accurately measure, on an on-going basis, the partial water vapor pressure with the aid of an infra-red measuring instrument. From the delivered measuring values and the known (previously several times at different pressures measured and in the computer 17 stored) flow resistance for the respective ‘chamber-condenser’ arrangement, it is possible to continuously ascertain the vapor flow and to calculate the transported water volume by means of temporal integration.

The following formula applies from the text book “Diels/Jeackel, Leybold Vacuum Handbook, second edition, Springer Publishing House 1962, pages 20/21 for the flow-through volume G of a gas in vacuum, for example water vapor

G=10³ o/W

with
o=gas density
W=flow resistance
   and for the flow resistance

W=12D/p1+p2

with
D=system characteristic
p1=partial water vapor pressure in the drying chamber
p2=partial water vapor pressure in the condenser chamber

D is determined by the length of the transport paths and their cross-sections, as well as by the friction coefficients of the gas. If one considers the friction coefficient, at known pressure, as constant under subject pre-requisites, it is possible to calculate G, dependent upon p1 and p2. If p2 is small versus p1, as is customary with freeze-drying, the accurate measuring of p1 suffices in order to obtain concrete values for G. The integral calculation of G, effective from the point in time of the start of freeze-drying up to the respective measuring moment provides the respective, at that point in time transported water volume.

A description is given, for example, on pages 129, 130 of the above mentioned text book of measuring the water vapor flow which depends upon the flow resistance in a freeze-drying facility. It greatly depends upon the partial water vapor pressure and because of the friction coefficient must be measured at several pressures.

With this method stored in the computer's memory, it is possible to document the freeze-drying process during the principal drying (sublimation drying) and also during the after-drying (desorption drying) by means of the already transported or the still present water volume.

Switching over from principal drying to after-drying, occurs, for example by increasing the placement plate temperature and by reducing the pressure in the chamber,—if an amount of water, depending upon product properties, is transported—for example 98%—or—relative to the solid matter—still presents a specified water contents as percentage of the solid matter—for example 8%. The final point of the after-drying is also directly measurable—specified, for example with 0.8%.

Arranged behind the computer 17 is a control device 19. Depending upon the results delivered by the computer, it is possible, with the aid of the control device to regulate the entire course of the freeze-drying process, for example the pressure in chamber 1, the placement surface temperature, actuation of valve 11, switch-over from principal—to after-drying etc. The structural elements required for such control procedures—such as valves, sensors etc—are not shown in detail.

The earlier specified pre-requisites for on-going accurate measurement of partial water vapor pressure with the aid of instrument 15 affect the type and the manner of how the interior of the drying chamber is laid out. The screening sheets 16 have already the effect that the temperature fluctuations at the instrument site are small. Additional screening units 21 are present, which are appropriately located between the placement surfaces and the lateral interior surfaces of the chamber. Screening units of this kind are disclosed in US 2004/250441A1. Their temperature can be appropriately regulated—independent of the placement surfaces—and prevent interfering influences of chamber wall temperature upon the product arranged inside the small bottles and thereby also upon the measuring instrument 15. Since in the area of the opening 10 to the condenser 3, water vapor flows must be expected to have higher velocities, the instrument is appropriately located in the upper region of chamber 1.

In the exemplary embodiment according to FIG. 1, the condenser 3 is connected with the opening 10 of freeze-drying chamber 1. Said opening 10, closable by means of valve 11, should be the narrowest location for transporting the water vapor to the condenser 3.

It is therefore appropriate to select the position of the valve plate 12 in its open position in such fashion that the area of the ring gap released by the valve is larger than the opening 10.

The drive 13 of valve 11 is located on the side of condenser 3 facing away from the opening 10. The connection member 22 between drive 13 and valve plate 12 traverses the concentrically wound and axially arranged pipe coil which forms the condenser surface 5. It may support a conical displacement body 23, whose diameter increases in the direction of the vapor flow. Its increasing diameter corresponds to the decrease in vapor volume.

In the lower side of the condenser 3 is provided a water drain 24. Said drain is opened during the thawing of the precipitated ice. The vacuum connection is identified with 25.

A line 26 arranged within the condenser chamber 4 ensures that the gas entry opening is arranged in the lower region of the condenser 3.

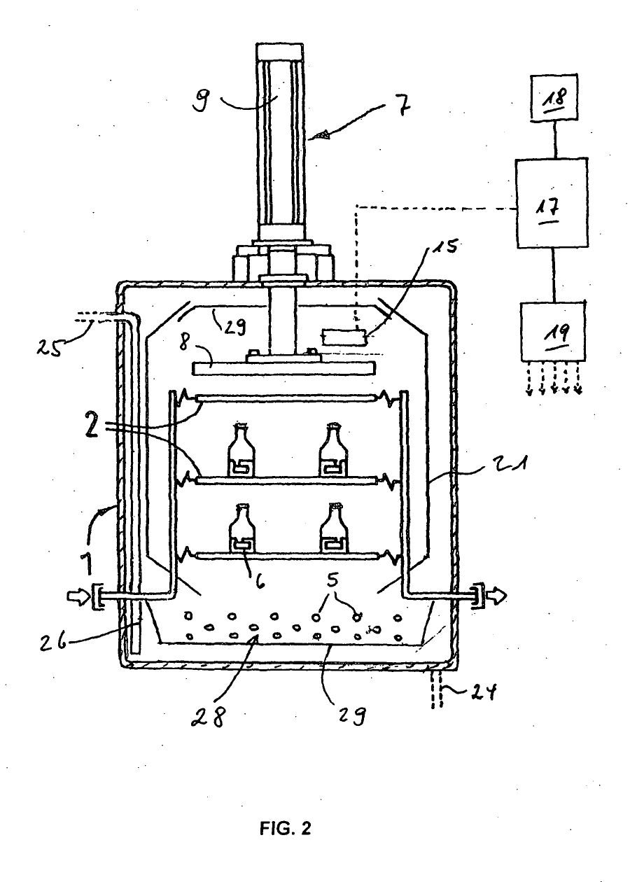

In the exemplary embodiment according to FIG. 2, the cold surfaces 5 of the condenser, comprising of a pipe bundle 28, are likewise arranged in chamber 1. As with condenser 3 according to FIG. 1, a water drain 24 and a vacuum connection 25, 26 is provided.

With water vapor analyzer 15, screening 16 is absent. Instead, provision is made not only for lateral screenings 21 of the placement surfaces 2, but also for additional screenings 29 above the placement surface 2 and below the pipe bundle 28. In addition to avoiding uneven temperature distributions in the area of the product, they also take care of constant temperature of the instrument 15.

If these measures are not sufficient for a constant temperature of instrument 15, there exist in general the possibilities of recording the temperature dependency of instrument 15, to store same in the computer 17 and to respectively convert the provided measured values to a constant temperature.

In the embodiment according to FIG. 2, the lower opening, determined by the lateral screenings 21, is decisive for the flow of water vapor. It can be made sufficiently large. If one assumes, for example, a drying chamber within the screenings having a width of 1.5 m, a height of 2 m and a depth of 1.5 m, it is possible to attain with approximately 25 cm free passage, a 5 m² transport area for the water vapor. With a valve having a free diameter of 1.2 m, which is technically the largest producible valve, approximately 1.1 m² transport surface are created.

The arrangement according to FIG. 2 has special benefits for freeze-drying at low pressures. As already mentioned several times in the text book “Freeze-Drying” pages 288, 289, in a drying room of 4.5 m, it is possible to locate approximately 20,000 bottles.

If during the principal drying an ice temperature of −42° C. needs to be maintained, then the pressure required to that effect amounts to approximately 0.06 mbar. That would require a valve having a diameter of approximately 1 m.

For systems operating at low ice temperatures and a multitude of bottles, for example 30 to 70,000, solutions with valves are technically no longer practical. Instead, provision may be made for not only round, but also long, slot-shaped openings, which has been demonstrated by the above-mentioned calculations.

In summary, the following benefits are attained by the invention:
retrofitting of existing systems with valve is possible
the technically maximum valve size—a little larger than 1 m—no longer limits the vapor transport, in particular with low pressures (for example less than 0.08 mbar). Chamber and condenser can be arranged in one space.
the valve between chamber and condenser can be eliminated. That is a significant cost factor in production facilities with large valves, including relative to operating safety (the eliminated valve will not produce any trouble).
without measurements as to increases in pressure, there no longer exists any argument that a derived magnitude is used for control of the process. The transported water volume is measured.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for freeze-drying products making use of a chamber with placement surfaces, whose temperature can be regulated and condensation surfaces, in which water issuing from the product in form of water vapor precipitates on the condensation surfaces, the method comprising:
during the course of the freeze-drying process taking measurements for documentation and control of the process, these measurements including on-going ascertainment of the water vapor flow between the product and the condensation areas as well as partial water vapor measurements, the water vapor flows being ascertained from the on-going measurements of the partial water vapor pressure and the flow resistance for the water vapor between the placement surfaces and the condensation surfaces; and
calculating water volume issued from the product in form of water vapor via temporal integration of the water vapor flow.

2. The method according to claim 1, further comprising:
measuring the flow resistance in a freeze-drying facility is once each for different pressures and storing these values, ascertainment of the water vapor flow takes place being dependent upon pressure.

3. The method according to claim 1, wherein the partial water vapor pressure is frequently measured, preferably 10 to 100 times per second.

4. The method according to claim 1, wherein the taking of measurements employs an instrument which utilizes the hydrogen absorption bands in the infra-red spectral range.

5. The method according to claim 4, wherein the temperature of the measuring instrument is adjusted to a pre-determined temperature.

6. The method according to claim 4, wherein a temperature dependency of the measuring instrument is recorded and stored and the supplied measuring values are respectively converted to a constant temperature.

7. The method according to claim 1, wherein a control unit is assigned to a computer and that the freeze-drying process is controlled on the basis of values ascertained by the computer.

8. A device for freeze-drying products making use of a freeze-drying chamber with placement surfaces whose temperature can be controlled and condensation surfaces in which water issuing from the product in form of water vapor precipitates on the surface of the condensation surfaces and in which, during the course of the freeze-drying process, measurements are taken for documentation and control of the process, the device comprising:
a measuring instrument for on-going measurement of the partial water vapor pressure; and
a computer with the aid of which the water vapor flow is calculated from the current measurements of the partial water vapor pressure and of the flow resistance of the water vapor between the placement surfaces and the condensation surfaces and, furthermore, a calculation is done by temporal integration of the water volume which issues from the product.

9. The device according to claim 8, wherein the measuring instrument is arranged within the freeze-drying chamber at a location where the flow velocity of the water vapor is small relative to the sound velocity.

10. The device according to claim 8, further including:
screening sheets, preferably temperature-controllable, assigned to the measuring instrument.

11. The device according to claim 8, further including:
screening units located between the placement surfaces and at least a part of the interior chamber surfaces.

12. The device according to one of claim 8, wherein the placement surfaces and the condensation surfaces are respectively located in the freeze-drying chamber and a condenser chamber, and the two chambers are connected with each other via an opening.

13. The device according to claim 12, further including:
a valve assigned to the opening and activatable on the side of the condenser chamber, the valve including a valve plate, preferably arched in the direction of the freeze-drying chamber.

14. The device according to claim 8, further including:
a displacement body located in the area of the condensation surfaces whose diameter increases in flow direction in accordance with the decrease of the vapor volume.

15. The device according to claim 12, wherein the opening is designed extending length-wise.

16. The device according to claim 8, characterized in that wherein the condensation surfaces are located in the freeze-drying chamber.

17. The device according to claim 16, wherein the condensation surfaces are located within screening units.

18. The device according to claim 8, further including:
a control instrument is provided, which controls, at least in part, the freeze drying process taking place inside the chamber on the basis of signals delivered by the computer.
